(19) United States
(12) Patent Application Publication
(10) Pub. No.: US 2025/0286439 A1
(43) Pub. Date: Sep. 11, 2025

(54) COOLING GUIDE AND MOTOR INCLUDING THE SAME

(71) Applicant: HYUNDAI MOBIS CO., LTD., Seoul (KR)

(72) Inventors: Jung Kyu YIM, Yongin-si (KR); Sang Jin KIM, Yongin-si (KR); Tae Woo KANG, Yongin-si (KR); Seung Ho LEE, Yongin-si (KR); Myung Jun GAM, Yongin-si (KR); Hee Soo PARK, Yongin-si (KR)

(73) Assignee: HYUNDAI MOBIS CO., LTD., Seoul (KR)

(21) Appl. No.: 19/033,956

(22) Filed: Jan. 22, 2025

(30) Foreign Application Priority Data
Mar. 6, 2024 (KR) 10-2024-0031763

(51) Int. Cl. H02K 9/19

(52) U.S. Cl. CPC H02K 9/19

(57) ABSTRACT

The present invention relates to a cooling guide for optimally conveying cooling oil. The cooling guide of the present invention is advantageous in that: the cooling oil can be allowed to move along a flow path from an outlet, by forming the cooling guide from an elastic material that is directly assembled to an inner diameter of a housing, so that the cooling guide can be tightly attached to the housing by a cooling guide assembling guide; a stator can be efficiently cooled even with a small amount of pressure, by positioning the flow path close to the oil outlet; a larger amount of cooling oil can be conveyed to the stator and a coil, by including an inclined surface; and a contact position between the oil and the stator can be more easily changed, by adjusting an inclined angle.

### CROSS-REFERENCE TO RELATED APPLICATIONS

This application claims priority under 35 U.S.C. § 119 to Korean Patent Application No. 10-2024-0031763, filed on May 6, 2024, in the Korean Intellectual Property Office, the disclosure of which is incorporated herein by reference in its entirety.

### TECHNICAL FIELD

The following disclosure relates to a cooling guide for optimally conveying cooling oil.

### BACKGROUND

A conventional oil-cooled motor, in which cooling oil is injected into a housing to cool a coil inside the motor, has a structure in which a groove is formed in a stator core (stator) and cooling oil is injected into a gap between the stator and the housing, or an oil pipe is included on a side surface of the stator, so that the cooling oil flows out into the housing. At this time, a cooling guide plate is installed at a position corresponding to the groove of the stator so that the sprayed oil is directed toward the coil, thereby including the cooling oil to hit the cooling guide plate and flow toward the coil.

However, the conventional cooling guide plate is made of a material with little elasticity, making it difficult to control its shape, resulting in many interference areas between the commonly used housing and its accessories, which causes difficulty in assembly. In this regard, in a case where the cooling guide plate is installed only at a partial portion of the housing, i.e., an upper portion of the housing, for convenience, there is a disadvantage in that the cooling oil flowing in from below is not sprayed in a direction toward the coil, and the coil is not smoothly cooled.

Furthermore, since the conventional cooling guide plate is formed to be flat without any curves, there is a problem in that the oil hitting the plate is not widely distributed but is sprayed only to a local location of the coil, resulting in a decrease in cooling efficiency. In addition, the conventional cooling guide plate is assembled onto a front cover with a bolt, resulting in an increase in size of the cooling guide and a significant waste of material.

### PRIOR ART DOCUMENT

### Patent Document

(Patent Document 1) Korean Patent Laid-Open Publication No. 10-2021-0026357 entitled “MOTOR HAVING COOLING SYSTEM” (Mar. 10, 2021)

### SUMMARY

An embodiment of the present invention is directed to providing a cooling guide capable of allowing the cooling oil to move along a flow path from an outlet, by forming the cooling guide from an elastic material that is directly assembled to an inner diameter of a housing, so that the cooling guide can be tightly attached to the housing by a cooling guide assembling guide, and capable of efficiently cooling a stator even with a small amount of pressure, by positioning the flow path close to the oil outlet.

Another embodiment of the present invention is directed to providing a cooling guide capable of conveying a larger amount of cooling oil to the stator and a coil, by including an inclined surface, and capable of more easily changing a contact position between the oil and the stator, by adjusting an inclined angle.

Another embodiment of the present invention is directed to providing a motor capable of reducing the cost of manufacturing and assembling parts, by changing a shape of a surface of the housing on which the stator is assembled and seated to be a predetermined inclined surface, making it possible to perform the same role as the above-described cooling guide, so that the same effect can be achieved even if the cooling guide is omitted.

In one general aspect, a cooling guide attached to a housing of a motor to guide a flow direction of cooling oil includes: an attachment portion having a predetermined thickness in a radial direction of the motor, with one end in the radial direction thereof being attached to the housing, and extending in an arc shape along a circumferential direction of the motor; and a partition wall portion integrally formed with the attachment portion at the other end of the attachment portion in the radial direction, and bringing the cooling oil flowing between the housing and a stator into a collision therewith to guide a spray direction of the cooling oil toward a coil, wherein the attachment portion includes an elastic material.

The partition wall portion may protrude in the radial direction of the stator, and the partition wall portion may include a partition wall inclined surface inclined at an end thereof, not perpendicular or parallel to a protruding direction of the partition wall portion.

The partition wall inclined surface may be formed on a surface facing upward based on the ground in a space where the housing is installed.

The attachment portion may include a grip portion extending toward an end in an axial direction of the stator at the other end thereof, with one surface of the grip portion being attached to an inner side surface of the stator.

The other surface of the grip portion may be inclined, not perpendicular or parallel to the radial direction and the axial direction of the motor.

The grip portion may have a groove having a predetermined depth in the axial direction of the motor on the other surface thereof.

The groove may have a circular cross section in the radial direction of the motor.

The groove may have a polygonal cross section in the radial direction of the motor.

At least one engagement hole engaged with the housing may be formed through the attachment portion.

In another general aspect, a motor including the above-described cooling guide includes: a housing having a central hole into which the stator is fitted, with the cooling guide being coupled to one end thereof, wherein the housing includes an integrated guide protruding from the other end thereof to have a predetermined length in an axial direction, and a surface of the integrated guide facing the stator is inclined, not perpendicular or parallel to the axial direction and the radial direction of the motor.

With the above-described configuration, the cooling guide of the present invention is advantageous in that the cooling oil can be allowed to move along a flow path from an outlet, by forming the cooling guide from the elastic material that is directly assembled to an inner diameter of the housing, so that the cooling guide can be tightly attached to the housing by the cooling guide assembling guide, and the stator can be efficiently cooled even with a small amount of pressure, by positioning the flow path close to the oil outlet.

In addition, the cooling guide of the present invention is advantageous in that a larger amount of cooling oil can be conveyed to the stator and the coil, by including the inclined surface, and the contact position between the oil and the stator can be easily changed, by adjusting the inclined angle.

With the above-described configuration, the motor of the present invention is advantageous in that the cost of manufacturing and assembling parts can be reduced, by changing the shape of the surface of the housing on which the stator is assembled and seated to be a predetermined inclined surface, making it possible to perform the same role as the above-described cooling guide, so that the same effect can be achieved even if the cooling guide is omitted.

### BRIEF DESCRIPTION OF THE DRAWINGS

FIG. 1 is a cross-sectional view of a motor to which a cooling guide of the present invention is applied.

FIG. 2 is a perspective view of the entire cooling guide of the present invention.

FIG. 3 is a partial perspective view illustrating a grip portion of the present invention.

FIGS. 4 and 5 are partial perspective views each illustrating an example of a shape of the grip portion of the present invention.

FIG. 6 is a perspective view illustrating a partition wall portion of the present invention.

FIG. 7 is a partial perspective view illustrating an integrated guide of the motor of the present invention.

### DETAILED DESCRIPTION OF MAIN ELEMENTS

1000: Cooling guide
100: Attachment portion
110: Grip portion
111, 112: Groove
120: Engagement hole
200: Partition wall portion
210: Partition wall inclined surface
2000: Motor
2100: Housing
2110: Integrated guide
S: Stator
C: Coil

### DETAILED DESCRIPTION OF EMBODIMENTS

Hereinafter, the technical idea of the present invention will be described in more detail with reference to the accompanying drawings. Further, terms or words used in the specification and claims herein should not be interpreted as being limited to the ordinary or dictionary meanings, but interpreted as meanings and concepts corresponding to the technical idea of the present invention based on the principle that the inventor can appropriately define concepts of terms to describe his/her invention in the best way.

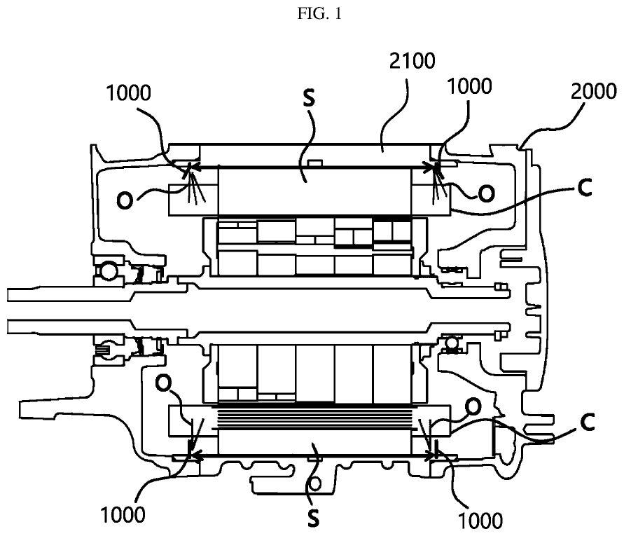

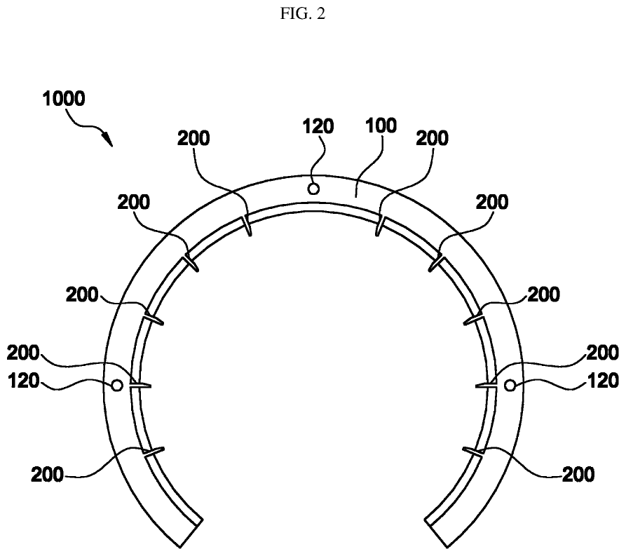

Hereinafter, a basic configuration of a cooling guide 1000 of the present invention and a connection relationship of the cooling guide 1000 with a motor 2000 will be described with reference to FIGS. 1 and 2.

As illustrated in FIG. 1, the cooling guide 1000 of the present invention is attached to a housing 2100 of the motor 2000 to guide a flow direction of a cooling fluid O. More specifically, the cooling guide 1000 of the present invention may include an attachment portion 100 and a partition wall portion 200 as illustrated in FIG. 2. The attachment portion 100 may have a predetermined thickness in a radial direction of the motor 2000, with one end in the radial direction thereof being attached to the housing 2100, and may extend in an arc shape along a circumferential direction of the motor 2000. That is, the attachment portion 100 may be formed in a C-ring shape.

In addition, at least one engagement hole 120 engaged with the housing 2100 may be formed through the attachment portion 100. Two or more engagement holes 120 may be formed along the circumferential direction of the motor 2000. Additionally, the attachment portion 100 may include an elastic material, thus minimizing interference with the housing 2100 of the motor 2000, and the cooling guide 1000 of the same specification may be applied regardless of the radial length of the housing 2100. As described above, the cooling guide 1000 of the present invention is attached at a location close to an outlet of the cooling fluid O, that is, a space between the housing 2100 and a stator S, thereby making it possible to smoothly bring the cooling fluid O into contact with the surface of the cooling guide 1000 without applying a high pressure to the cooling fluid O, so that the stator S can be cooled more efficiently.

In addition, the cooling guide 1000 of the present invention may include a partition wall portion 200 formed integrally with the attachment portion 100. The partition wall portion 200 may be formed at the other end of the attachment portion 100 in the radial direction, and may bring the cooling fluid O flowing between the housing 2100 and the stator S into a collision therewith to guide a spray direction of the cooling fluid O toward a coil C.

The partition wall portion 200 may include an elastic material. For example, the partition wall portion 200 may be made of the same material as the attachment portion 100, and molded and manufactured together with the attachment portion 100. By including the partition wall portion 200, the cooling fluid O flowing along the attachment portion 100 can be blocked to induce the cooling fluid O to contact the coil C. In addition, the attachment portion 100 and the partition wall portion 200 of the cooling guide 1000 of the present invention may be coated with an insulating material on their surfaces. Accordingly, safety accidents caused by unnecessary short circuits can be prevented.

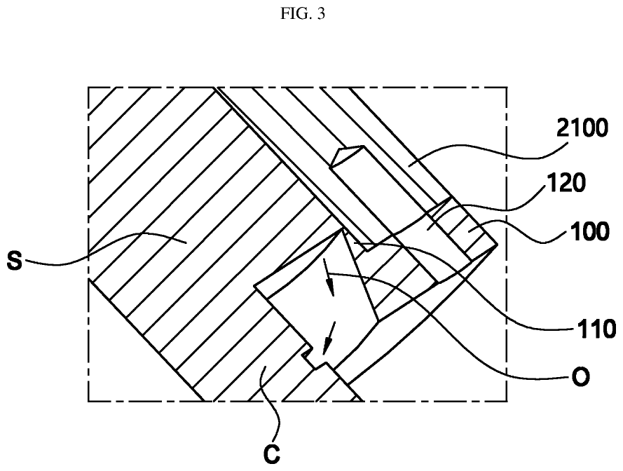

Hereinafter, the attachment portion 100 of the present invention will be described in more detail with reference to FIGS. 3 to 5.

As illustrated in FIG. 3, the attachment portion 100 may include a grip portion 110 extending toward an end in an axial direction of the stator S at the other end thereof, with one surface of the grip portion 110 being attached to an inner side surface of the stator S. By including the grip portion 110, the attachment portion 100 may be more firmly coupled to the housing 2100. In this case, the other surface of the grip portion 110 may be inclined, not perpendicular or parallel to the radial direction and the axial direction of the motor 2000. By forming the inclined surface in the grip portion 110, the cooling fluid O can be conveyed to the end coil C, which is a main heating part protruding outward of the stator S, when flowing along the inclined surface. In this case, the phase difference between the inclined surface of the grip portion 110 and the axial direction of the motor 2000 may be determined in consideration of the target flow direction of the cooling fluid O.

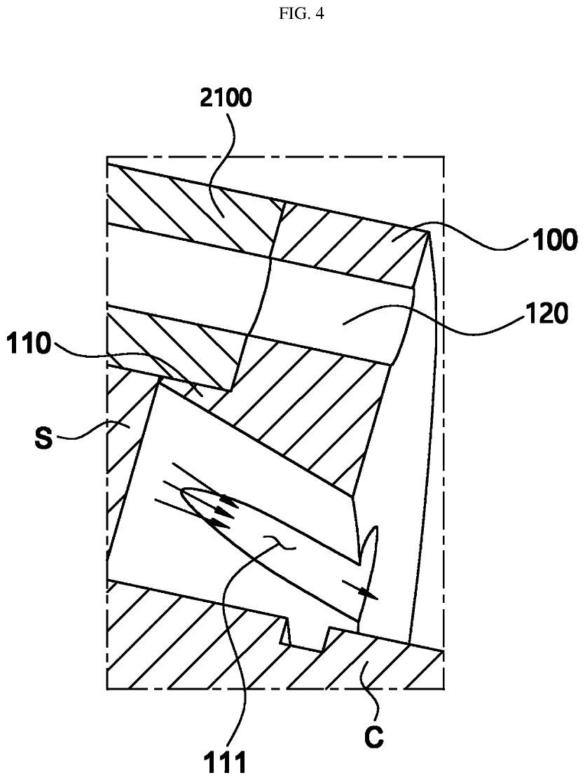

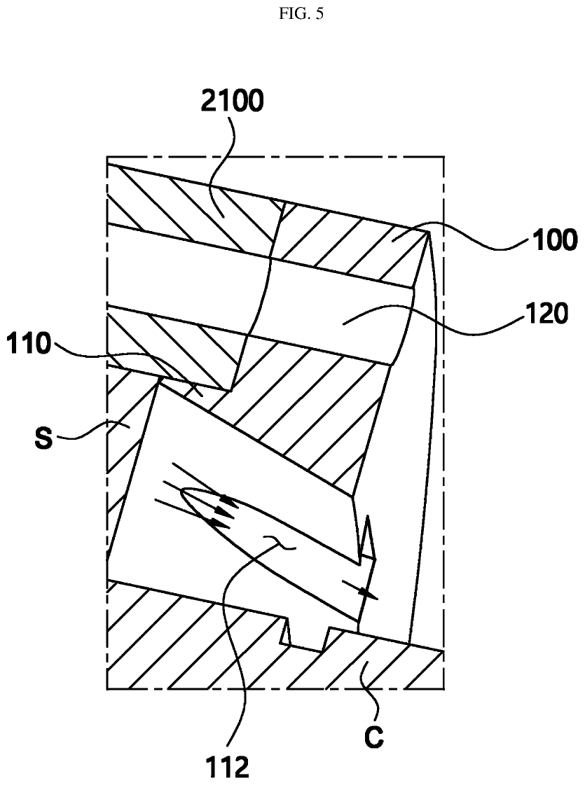

In addition, the grip portion 110 may have a groove 111 or 112 having a predetermined depth in the axial direction of the motor 2000 on the other surface thereof. Accordingly, the cooling fluid O sprayed into a gap between the housing 2100 and the stator S can flow to gather into the groove 111 or 112 formed in the grip portion 110, and the flow of the cooling fluid O can be controlled more smoothly. More specifically, as illustrated in FIG. 4, the groove 111 formed in the grip portion 110 may have a circular cross section in the radial direction of the motor 2000. Alternatively, as illustrated in FIG. 5, the groove 112 may have a polygonal cross section in the radial direction of the motor 2000. In this case, the shape (depth, cross-sectional size, and shape) of the groove 111 or 112 may be determined in consideration of the properties of the cooling fluid O, the flow rate, and the specifications of the stator S and the housing 2100 so that the cooling fluid O flows along the surface of the groove and then falls toward the end coil C.

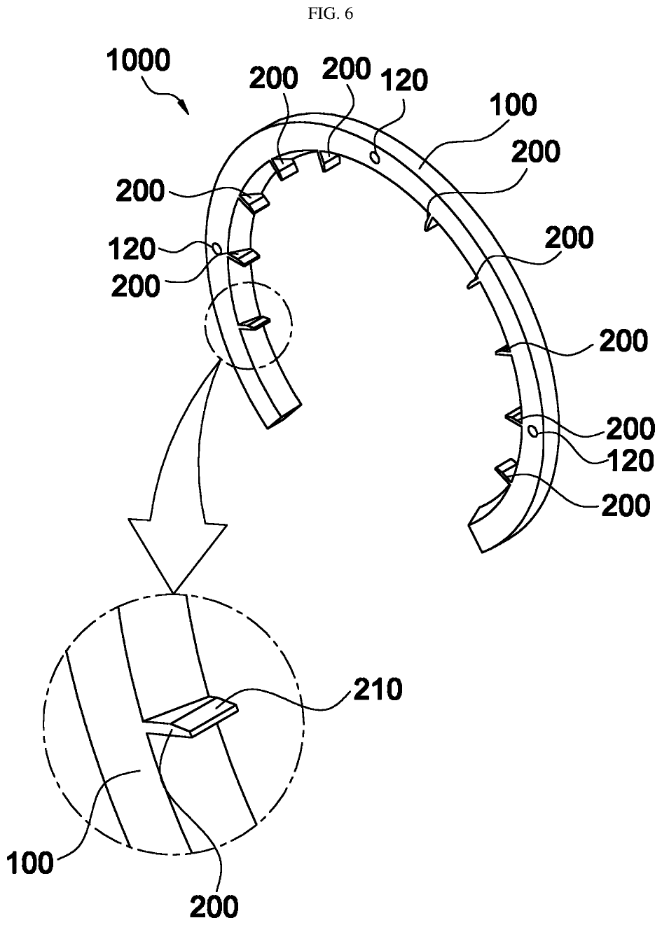

Hereinafter, the partition wall portion 200 of the present invention will be described in more detail with reference to FIG. 6.

As shown in FIG. 6, the partition wall portion 200 may protrude in the radial direction of the stator S. Accordingly, the cooling fluid O can be prevented from flowing back while flowing along the surface of the attachment portion 100. More specifically, when the cooling fluid O sprayed between the housing 2100 and the stator S flows along a partition wall inclined surface 210 formed in the grip portion 110, the cooling fluid O can be prevented from being conveyed to the inside of the stator S rather than contacting the end coil C protruding outward of the stator S.

In addition, the partition wall portion 200 may include a partition wall inclined surface 210 inclined at an end thereof, not perpendicular or parallel to the protruding direction of the partition wall portion 200. In this case, the angle between the partition wall inclined surface 210 and the protruding direction may be determined in consideration of the target flow direction of the cooling fluid O. In addition, it is preferable that the partition wall inclined surface 210 is formed on a surface facing upward based on the ground in a space where the housing 2100 is installed. Accordingly, when the cooling fluid O is sprayed from above, the cooling fluid O can be brought to fall toward the coil C after contacting the partition wall inclined surface 210, which makes it easy to adjust the flow direction of the cooling fluid O.

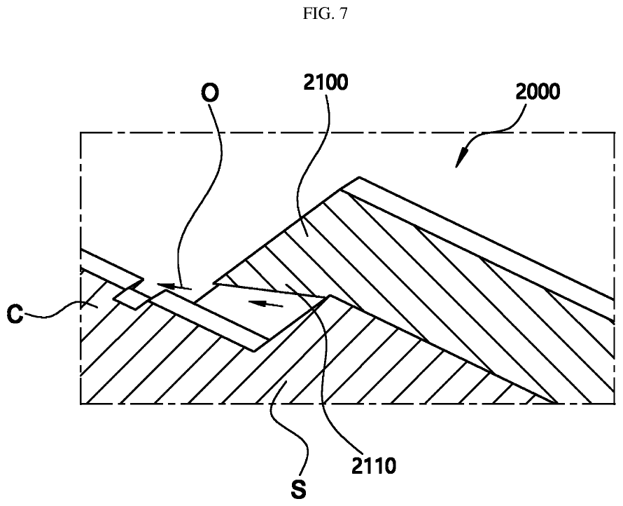

Hereinafter, the motor 2000 of the present invention and its detailed configuration and embodiment will be described in more detail with reference to FIG. 7.

As illustrated in FIG. 7, the motor 2000 of the present invention may include a housing 2100 having a central hole into which the stator S is fitted, with a cooling guide being coupled to one end thereof. The housing 2100 may be made of a metal material. In this case, the housing 2100 may include an integrated guide 2110 protruding from the other end thereof to have a predetermined length in the axial direction. The integrated guide 2110 may be made of the same material as the housing 2100, and may be molded and manufactured together with the housing 2100. The integrated guide 2110 may have the same shape as the cooling guide 1000 described above, and may perform the same role (a role of guiding the cooling fluid O). Accordingly, even if a cooling guide is not applied to the other end of the housing 2100, the same effect of guiding the cooling fluid O in the desired flow direction can be achieved, thereby reducing the cost of manufacturing and assembling parts.

More specifically, the surface of the integrated guide 2110 facing the stator S may be inclined, not perpendicular or parallel to the axial direction and the radial direction of the motor 2000. By forming the inclined surface in the integrated guide 2110, the cooling fluid O can be conveyed to the end coil C, which is a main heating part protruding outward of the stator S, when flowing along the inclined surface. In this case, the phase difference between the inclined surface of the grip portion 110 and the axial direction of the motor 2000 may be determined in consideration of the target flow direction of the cooling fluid O.

In addition, as an example, the integrated guide 2110 may also be formed at one end of the housing 2100 as well as the other end of the housing 2100. Accordingly, it is possible to reduce the cost of manufacturing and assembling parts when manufacturing the cooling guide. As another example, the surface of the integrated guide 2110 may have the same shape as the above-described partition wall portion 200. Accordingly, the cooling fluid O can be prevented from flowing back while flowing along the surface of the integrated guide 2110. More specifically, when the cooling fluid O sprayed between the housing 2100 and the stator S flows along an inclined surface formed in the integrated guide 2110, the cooling fluid O can be prevented from being conveyed to the inside of the stator S rather than contacting the end coil C protruding outward of the stator S.

The technical idea should not be interpreted as being limited to the above-described embodiments of the present invention. The present invention is applicable in a variety of ranges, and may be modified in various manners by those skilled in the art without departing from the gist of the present invention claimed in the claims. Therefore, such improvements and modifications fall within the protection scope of the present invention as long as they are obvious to those skilled in the art.

What is claimed is:

1. A cooling guide attached to a housing of a motor to guide a flow direction of cooling oil, the cooling guide comprising:
an attachment portion having a predetermined thickness in a radial direction of the motor, with one end in the radial direction thereof being attached to the housing, and extending in an arc shape along a circumferential direction of the motor; and
a partition wall portion integrally formed with the attachment portion at another end of the attachment portion in the radial direction, and bringing the cooling oil flowing between the housing and a stator into a collision therewith to guide a spray direction of the cooling oil toward a coil,
wherein the attachment portion includes an elastic material.

2. The cooling guide of claim 1, wherein the partition wall portion protrudes in the radial direction of the stator, and
the partition wall portion comprises a partition wall inclined surface inclined at an end thereof, not perpendicular or parallel to a protruding direction of the partition wall portion.

3. The cooling guide of claim 2, wherein the partition wall inclined surface is formed on a surface facing upward based on the ground in a space where the housing is installed.

4. The cooling guide of claim 1, wherein the attachment portion includes a grip portion extending toward an end in an axial direction of the stator at the other end thereof, with one surface of the grip portion being attached to an inner side surface of the stator.

5. The cooling guide of claim 4, wherein another surface of the grip portion is inclined, not perpendicular or parallel to the radial direction and the axial direction of the motor.

6. The cooling guide of claim 5, wherein the grip portion has a groove having a predetermined depth in the axial direction of the motor on the other surface thereof.

7. The cooling guide of claim 6, wherein the groove has a circular cross section in the radial direction of the motor.

8. The cooling guide of claim 6, wherein the groove has a polygonal cross section in the radial direction of the motor.

9. The cooling guide of claim 1, wherein at least one engagement hole engaged with the housing is formed through the attachment portion.

10. A motor including the cooling guide of claim 1, the motor comprising:
the housing having a central hole into which the stator is fitted, with the cooling guide being coupled to one end thereof,
wherein the housing includes an integrated guide protruding from another end thereof to have a predetermined length in an axial direction, and
a surface of the integrated guide facing the stator is inclined, not perpendicular or parallel to the axial direction and the radial direction of the motor.
